(19) United States
(12) Patent Application Publication
(10) Pub. No.: US 2016/0307028 A1
(43) Pub. Date: Oct. 20, 2016

(54) Storing, Capturing, Updating and Displaying Life-Like Models of People, Places And Objects

(71) Applicant: Mikhail Fedorov, Cerritos, CA (US)

(72) Inventor: Mikhail Fedorov, Cerritos, CA (US)

(21) Appl. No.: 15/130,964

(22) Filed: Apr. 16, 2016

Related U.S. Application Data
(60) Provisional application No. 62/148,244, filed on Apr. 16, 2015.

(51) Int. Cl. G06K 9/00; G06T 11/60; G06F 17/30; G06T 7/20

(52) U.S. Cl. CPC G06K 9/00268; G06K 9/00315; G06K 9/00335; G06T 7/20; G06K 9/00288; G06T 11/60; G06F 17/3007; G06T 2207/30201

(57) ABSTRACT

A digital processing application may provide identifying a present context associated with user data submitted to an interactive application and retrieving a content file stored in memory. The process may also include identifying a present context associated with user data submitted to an interactive application, retrieving at least one content file stored in memory, retrieving a plurality of attributes associated with the at least one content file, modifying the at least one content file to include the plurality of attributes, and updating a user interface to include the modified at least one content file.

### FIELD OF INVENTION

The present invention relates to the capturing and storing of images or other content and associating such content with an application to automatically create and update an avatar or other model to visually represent a present context.

### BACKGROUND OF THE INVENTION

When users interact with online or offline applications they often communicate with words, voice and/or other communicating mediums. The users may also value life-like visualizations of their counterparts. That's why video communication is gaining ground despite its higher cost as compared to capturing, transmitting and replicating voice or photos. However in many cases direct life-like visualization (for example, using a videoconferencing connection) is impossible or impractical. For example, a FACEBOOK page would not normally have live streaming data of a person's video and neither would a photo frame. In other cases, like a low-bandwidth conferencing, sending a full live-video stream would cause delay of the communication line, resulting in poor quality of the connection. In yet other cases, a counterpart may choose not to allow a live video connection for privacy reasons, for example receiving a call while in a compromising situation. In either case, when a life video connection is impossible or impractical, it's possible to create an avatar model, with information about person's visual, physical and behavioral characteristics, to represent the person by showing a life-like video sequence similar to what it could be if the live video streaming were possible.

### SUMMARY OF THE INVENTION

Example embodiments of the present application disclose hardware, software and/or operations and procedures configured to identify a present context associated with user data submitted to an interactive application, retrieve at least one content file stored in memory, retrieve at least one attribute associated with the at least one content file, modify the at least one content file to include the at least one attribute, and update a user interface to include the modified at least one content file.

### BRIEF DESCRIPTION OF THE DRAWING(S)

FIG. 1 illustrates a logic diagram of a data content source and corresponding avatar creation application, in accordance with example embodiments.

FIG. 2A illustrates another logic diagram of displaying and modifying an avatar in accordance with a user interface, in accordance with example embodiments.

FIG. 2B illustrates a timeline of modifying an avatar in accordance with a user interface, in accordance with example embodiments.

FIG. 3 illustrates yet another logic diagram of various data input and data output portions of a control logic used to create content and modify content automatically based on known user input and pre-stored data content, in accordance with example embodiments.

FIG. 4 illustrates an example system communication diagram, according to example embodiments.

FIG. 5 illustrates an example graphical user interface including a voice application and avatar insertion module, according to example embodiments.

FIG. 6 illustrates an example flow diagram of an example method according to an example embodiment.

FIG. 7 illustrates an example network entity device configured to store instructions, software, and corresponding hardware for executing the same, according to example embodiments.

### DETAILED DESCRIPTION OF THE EMBODIMENT(S)

Example embodiments may provide a procedure to capture, store, transmit and display life-like models of people, places and objects. Such models may be created and modified dynamically depending on a detected status of the object. For instance, the original object status could change depending on certain circumstances. In one example, a set of images, video or other content may be used to represent a person, place, destination, etc., and incorporated into a user application, such as a social networking application, video conferencing application, an electronic photo frame, a screen saver.

Example embodiments provide visualizing the person, place or object in a broader variety of situations than existing means of photography and/or video recording to drastically reduce bandwidth/storage requirements and transmission/recording of images and video streams, e.g. videoconferences. Using a series of photographs or/and video records, the target object (i.e., person/place/object) may be configured as multiple essential parts. For instance, a user may have an interaction which can be categorized by a particular facial gesture (e.g. eyes open or closed, lips neutral or smiling). The object description can be selected and enacted based on a standardized format of the components and their observed interactions. For example, the content may be stored and/or transmitted as packet data once instead of each each time the content is retrieved to make an object impression.

Preparing an object model may include retrieving a neutral state of the model from a base content file (i.e., straight face user photograph, well-lit background of a location or fixed object). Next, the object model may be displayed with a random variation of the observed interaction of elements (i.e., photo frame mode, overlaid special effects, etc.) or a combination of elements/interactions different than those observed by predicting the behaviors not yet observed, or control the visualization from a remote system that would send the currently observed coordination of model elements (e.g., videoconferencing with low bandwidth requirements). As a result, the object model may provide a visually pleasing, aesthetic and emotionally-rich “living” visual representations of people, places or inanimate objects. Such representations of the object models may be based on a best possible avatar to replace static drawings, photos, or simple video sequences in applications where richer visual representation create value (e.g., user profile images in social media applications, communication systems (teleconferencing), electronic photo frames and computing device screen savers.

The neutral state of the model refers to a general description of sub-objects and their properties/relationships of more complex objects, such as a human face includes two eyes, one nose, lips, etc. The nose is above the lips but below/between eyes, the nose is largely immobile, while eyes can blink and lips can smile or frown. Different states of the same model would be for the case of the Mona Lisa object to be smiling, crying, frowning, speaking, singing, etc. The object model modification algorithm may take a location, person or inanimate object and modify the generic or base model of that object model into a broader variety of situations than merely existing frames of photography or a video recording can capture. For example, by identifying triggers and extrapolating known behaviors (e.g., happy, sad, angry, excited, funny, irate, etc.) into unknown situations, a user's image or a location may be modified to fit the categorization of a present context. One example may include a user stating his or her feelings via a blog posting in a social networking application. The statements can be parsed and matched to a library of context which is linked to a modification variable (e.g., ‘not happy’=10% increase in frowning mouth). Another example may be a news feed about a dangerous weather pattern modifying a landmark image to accommodate the status of the weather. For instance, if a tornado system is passing through Oklahoma City and the trigger detection module identifies the news feed regarding the weather update, then the known or cached images of Oklahoma City may be automatically modified to darken the sky, flip one or more objects upside down and display this modified object model to the user interface on the weather report. The report in this example may have various objects, placement positions and/or relationships that are identified and modified depending on the severity of the weather report. For example, when the image has a piece of paper on the street and various light objects in the background, a light wind (e.g., 20 mph winds extracted from the weather report) may cause a first state of being for those dynamic objects, such as a change in position, a change in angle, etc. As the report puts larger winds at the same scene (e.g., 50 mph winds also parsed from the report), then, in this case, the modifier signals or variable changes would disturb the originally calm model making the sky darken and the objects fly higher. A more moderate example would be a lake that could show a windy day with less smooth/reflecting waters and small waves added to a quiet base model.

According to other examples, in order to define an “avatar” file format, describing multiple important properties of the original object (e.g. person, animal, inanimate object or location, a two-dimensional and/or three-dimensional model of the image and its corresponding key elements may be created as a template or foundational object model which can then be modified based on the suspected or predicted change of the object, including geometry, color and/or texture. For example, for a person's portrait, such key components could be the eyes, mouth, eyebrows, etc. The elements can belong to the objects or to other elements. Relationships between those key elements, including geometrical relationships, properties of attachment (e.g. loose or firmly attached) may also be established. For example, eyes are located in a specific part of the face and are firmly attached to the face, while the mouth may be loosely attached as it opens and shuts and moves around.

Another association of the objects and the dynamic changes that occur to those objects may include a mutual behavior of the objects, such as a mutual behavior indicator that both eyes most often blink together or information about interaction of key elements during a smile including the eyes being open and the mouth being arced in a smile position. Patterns of collective behavior of objects may also be identified as attributes used when modifying an avatar object model. For example, a person smiles 12% of the time may indicate a likelihood of a smile is less than expected and as a result should not be default modification to an object model.

The model or avatar of the person, place, object, etc. may be defined by its default parameters which are created with the model and maintained until variables are received to identify changes to that model. The model's default parameters may be modified or shifted to increase or decrease a default position of any attribute of the model. For example, a user's face may have various attributes, such as mouth position, eye position, eyebrow position, etc. which can be modified to show changes in the model's disposition. For example, certain random transitions between 20% of a smile, 75% of a neutral position and 5% of a sad frown, etc., may be preset in a model generator module's default parameters and could be overridden by a person or module creating the model and/or modifying the model. As the model is linked to a live session with dynamic variables, the model would be able to explicitly change preferences to set more smiling percentages and to have less of a neutral position. Also, the model's behavior would be adjusted by modifying signals of the visualizing equipment or modules. In operation, the procedure of modifying the model may include establishing modeling materials (i.e., photos/videos) to have a certain proportion of “observed behaviors”, including a 5% smile and/or a 95% neutral face. A model generator module may offer a standard default for the model, such as 10% of a smile and 90% of a neutral face position, subject to other modifiers during the model view procedure. A user creating the model may have an option to reset the defaults from a standard 10/90 neutral approach to actually observed, such as the 5/95 case or any other values of choice. This may then become the model's default settings. Another user viewing the model would see it according to the model's default settings, visualizing equipment preferences and visualizing equipment modifying signals. For example, if the model were created with 90/10 default settings, in absence of different preferences settings or modifying signals on visualizing equipment 90/10 will be the actual model behavior. Or, with a “more smile” preference on the visualizing equipment, the smile may turn to an 85/15 ratio. Or, alternatively, with a “cloudy day” signal from a visualizing equipment (e.g., sensors) an option may show a 95/5.

The process of creating the avatar object model file may include utilizing captured or existing content files, including video streams analyzed frame-by-frame via visual recognition technology, photos analyzed together via visual recognition technology. Default templates, e.g. defining hierarchies of key elements for people, dogs or cats. Explicit choices of the person creating an avatar, e.g. choosing to show a smile of the face 50% more often than in the existing video streams or photos.

The process of updating the avatar file based on new materials may include merging new video streams, photos, templates and explicit choices to enrich the model of the object, enabling more realistic representation. Also, overlaid backgrounds and other objects may create new contexts based on suspected changes to a base object model (e.g., weather background at a location, movement of objects to indicate changes, weather, etc.). A generic object image may be superimposed upon a modified object or image to make the modified object. Superimposing may include rendering a final image from information about the model that is received and a state associated with the model.

The process of defining and displaying the avatar object based on the existing avatar file object model and the controls may include displaying the avatar's default settings (i.e., template) by re-creating the object on the screen from its key elements using the information about relationships, mutual behaviors and collective behavior patterns. Display the object using external controls, such as during a videoconference when guiding information is transmitted through communication channel. Display using manual controls, e.g. to observe extrapolated behaviors not originally existent in the materials that the avatar was built on.

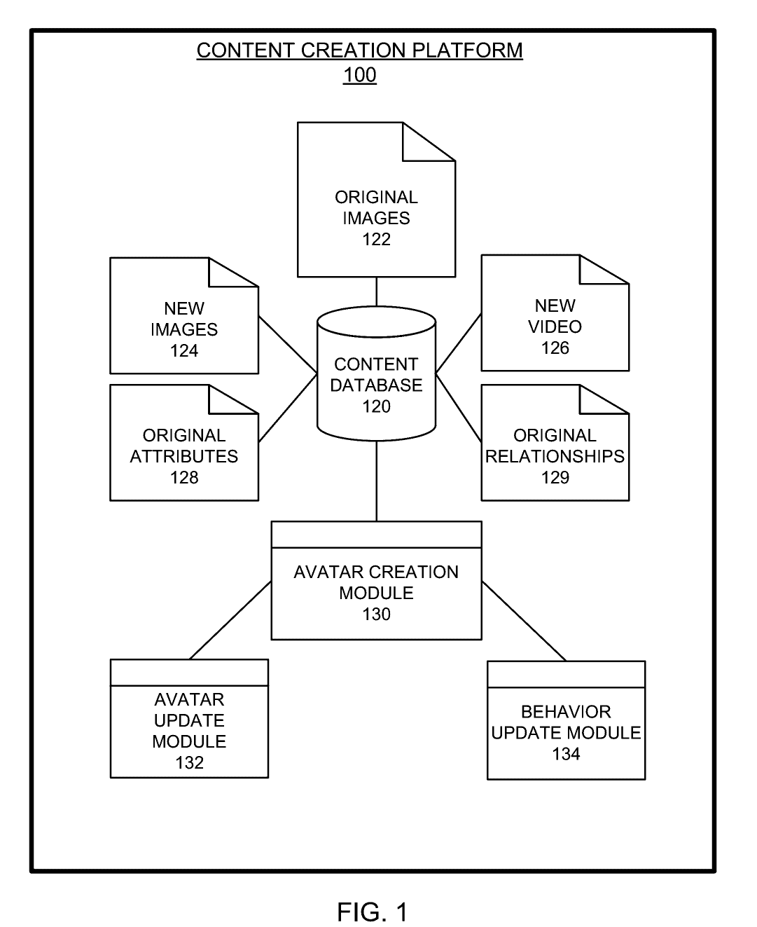

In one example embodiment, as generally depicted in FIG. 1, the logic configuration 100 includes a content creation platform that can be used to store, retrieve and create content that can be linked to the user of an application. A content database 120 may be a section of a server or a dedicated databank used to store original images 122, new images 124, new video 126 and other content related to certain interests associated with a user from previous conversations, photos, or other actions taken by the user to generate such content. The content may also have original attributes 128 that define the content and original relationships 129 that link the content to certain contexts identified during a call, a social interaction session, etc. Once a context is identified, the avatar creation module 130 may exist as part of the application tracking the user input and contextual interactions and may provide an avatar creation function that uses known behaviours 134 and avatar data 132 to update a generic avatar template and change the user image or location data, etc.

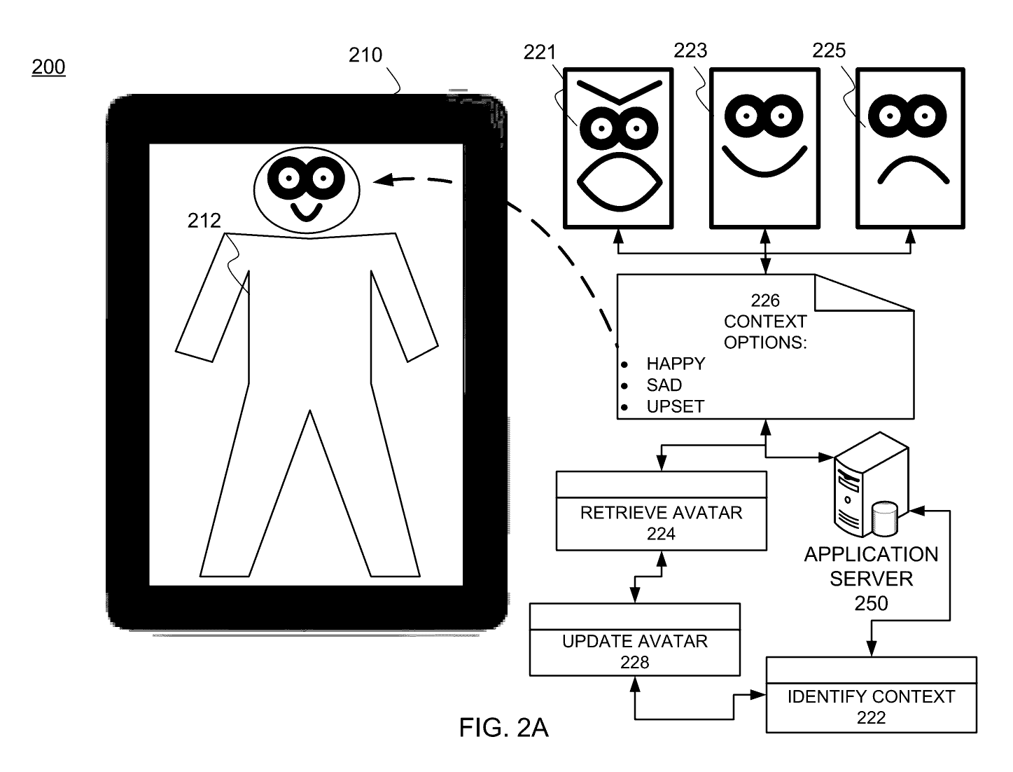

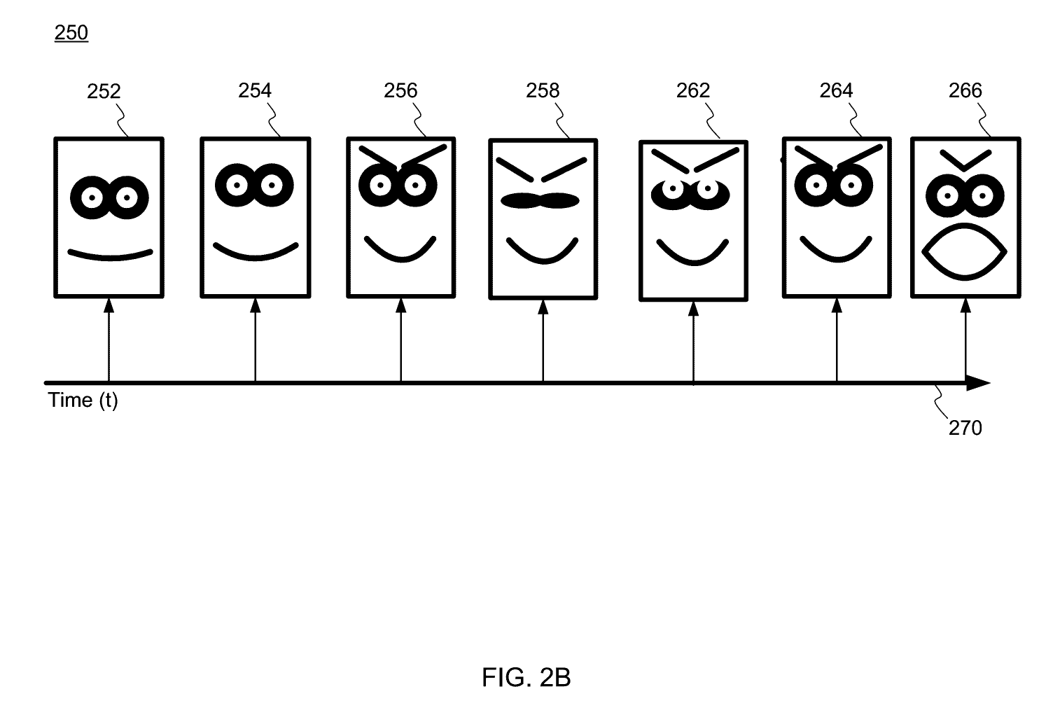

FIG. 2A illustrates an example user interface avatar creation and modification diagram 200 according to example embodiments. Referring to FIG. 2A, the user computing device 210 may have an avatar creation setup 212 received by a third party application via an application server 250 or other computing source. In operation, a user may be accessing an application that identifies a context, which in this example may be a user avatar or model of the user to express sentiment during an online session with other users. Other examples may be images of locations discussed during the conversation or other objects discussed. The user may have a template object 212 modified to include the eyes and mouth or other facial features of the various different possibilities available including angry 221, happy 223 and sad 225. The context options 226 may list the possible changes to the template avatar and attempt to pair them with the context of a discussion. Words may be parsed from the user input, such as “Today is a [great] day, I'm [happy] as can be with the results” and pair those results with a context label such as “happy” stored in the context options 226. Next, an image or portions of an image can be linked to the user avatar object to change the image context to a happy face without any user effort and without having a user photograph that is specified as the user being happy, the image can be created to accommodate the context detected. The application server 250 may retrieve the context options, parse the user input and select one or more content options to share with the changed user avatar. The avatar can be retrieved 224 and updated 226 to accommodate the changes based on the identified context 222.

In one example, the avatar transition model may be based on a timeline of changes and transitions corresponding to the overall mood and current status of a user associated with the avatar. For example, the avatar transition and mood selection algorithm may identify a certain degree of mood discerned from a context of recent postings, articles selected, comments made at other online locations, etc. The operations may include identifying a dominant and current mood, a relative degree of mood, such as a percentage (i.e., 20% happy, 80% normal; 25% happy, 35% startled, 40% normal, etc.). Whatever the current mood disposition that is identified, the avatar modification process may be setup to include a timeline of events. The events may include an initial state, a modification or transition state, a modified state, an additional modification or transition state “phase-out” state, and a final state prior to ending the transitions and the timeline of state changes. For example, a status change to the avatar face may include a total of 20 seconds. During this 20 second time interval, there may be 4-5 eye blink events each lasting approximately 1 second each, there may also be 2-3 transitions to a state change, such as smiles, or mouth modifications and there may also be a period of returning to normal or a regular/serious face portion of the timeline used to end or complete the timeline of changes.

One example of a timeline of avatar modifications may include 10 seconds of a serious face with a 0.2 second blink, a 2 second transition to a smile, a 2 second smile, another 0.2 second blink, and a 3 second transition back to a serious face. Such a sequence of transitions would be indicative of a modest amount of excitement, such as a pleasing disposition as opposed to an ecstatic disposition or a sad or depressed disposition. The various modifications and transitions to the avatar may be included in an avatar modification sequence which includes a predefined number of transitions, a relative degree of excitement (i.e., 10%, 20%, 50%, etc.) whether it be happy, sad, horrified, overwhelmed, etc., and a total period of time of avatar modifications. The modification sequence may begin with an initiation operation, such as a particular user accessing a particular posting, article or other contextual event. The initiation may be performed by scrolling onto the event in a web browser, and thereafter, the sequence may begin and may correlate with the length of the posting, for example, if the posting is 5-10 lines then the sequence may be 10 seconds which is approximately the amount of time the reader is able to read the entire posting.

FIG. 2B illustrates a timeline of avatar changes in accordance with example embodiments. Referring to FIG. 2B, the timeline 250 is an example of a series of avatar facial expressions which may be incorporated into a contextual expression of a user posting or other contextual user expression of feelings. For example, assuming a user has submitted a blog posting, a social network posting, a conference call submission of statements, etc., the comments may be parsed, processed and a general emotion or feeling may be discerned from the statement along with a degree of the emotion. Also, multiple emotions may be identified along with a degree of emotion for each emotion identified. For example, a user statement may include certain terms which indicate the user is happy, excited, afraid, ecstatic, angry, hopeful, depressed, agitated, interested, etc. The number of words which match any of those emotions may be one indicator of a degree of emotion. For example, one or two words indicating happiness may equate to a relative degree of emotion of 25 to 30% happy vs. four or even more words of happiness which may indicate a degree of emotion of 75-80%. Each set of words may be identified as having more than one emotion and a corresponding degree of emotion. For example, the timeline 270 in the example of FIG. 2A includes various facial expressions, transitions and an amount of time to maintain such facial expressions and the related transitions. The various facial changes 250 includes a first facial expression 252 as “serious” or “neutral”, the second face may be a transition to a smile 254, followed by a half smile 256. The half-smile 256 may be held for several seconds until a necessary blink of the eye transition is inserted 258, which may indicate a transition to another smile of a larger degree or a different emotion altogether. The blink 258 transition may transition to an eye being partially opened 262 transition and a full smile 264 prior to an ecstatic face 266 which is based on a second context identified from the user statement. In general, the transition facial images, such as 254, 258 and 262 may occur faster and last shorter times, such as 0.2 seconds, etc., than those primary facial expressions which may last for several seconds, such as 2-3 seconds.

One example method of operation may include identifying a present context associated with user data submitted to an interactive application. The context can be based on a user emotion identified from one or more words included in the user submitted statements or events linked to the user, such a recent changes (i.e., job change, engagement to be married, etc.). Next, at least one content file stored in memory can be retrieved to include a simple or basic avatar used to represent the person linked to the identified content, such as a user profile image, headshot image, etc. The content file may be a serious face or neutral basis image of the person's face or of anyone's face or a cartoon or fictitious image face. Next, a plurality of attributes associated with the at least one content file can be retrieved, such as changes to the face, including mouth, eyes, eyebrows, cheeks, hair, etc. Next, the content file can be modified include the plurality of attributes based on an ordered timeline of changes. For example, the first image may be a neutral face then a transition to a smile which include changes to the mouth only or other changes as well. Also, a transition to a blink may be used to make the content file appear more organic and dynamic The user interface of another user or the user in the image file may be updated to include the modified content file. Also, a series of updates may then be received to reflect the various expressions to the user's face over a predefined period of time. In general, this time period may be directly associated with the amount of words written by the user so the reader can read the words and view the user's facial expressions in a relative degree of synchronicity between the facial expressions and the user's progress reading the posting. The longer the posting, the more facial expression changes are likely to be identified and included in the timeline.

The present context is identified based on a parsing of terms included in the user data. The terms are then processed to identify a user emotion and a numerical degree of emotion, such as how excited or sad is the user based on the contextual meaning identified. The content file generally include an image of a face. The attributes include at least one facial feature of the face or portion of the face. A timeline is created to include all the modifications to the content file including a plurality of transitions and modifications to the content file over a predefined interval of time, and the timeline of modifications are added to the content file and the content file is modified based on the transitions and the modifications appear in the timeline. The modified content file is displayed with the modifications and the transitions to the content file over the predefined interval of time. The plurality of facial expressions are modified based on the plurality of attributes, and the modified content file includes a plurality of facial expressions and facial feature movements over the predefined interval of time.

Any of the facial expressions, transitions, etc., may be based on a plurality of images layered as a series of images, such as a GIF file series to illustrate movement based on a small number of images. In general, digital movies are still a series of images, however, movies require tremendous amounts of images and audio and quality as well which makes files sizes large in size. As a result, by using only a few images in a particular timeline of images, the file sizes may be small and easy to assemble without arduous bandwidth requirements. The timeline size may be based on the size of the user submitted posting and contexts discerned from that posting. In other words, if a user makes various statements and writes a 15 sentence paragraph, then multiple facial expressions may be identified and used to create more expressions, more transitions and ultimately longer facial timelines.

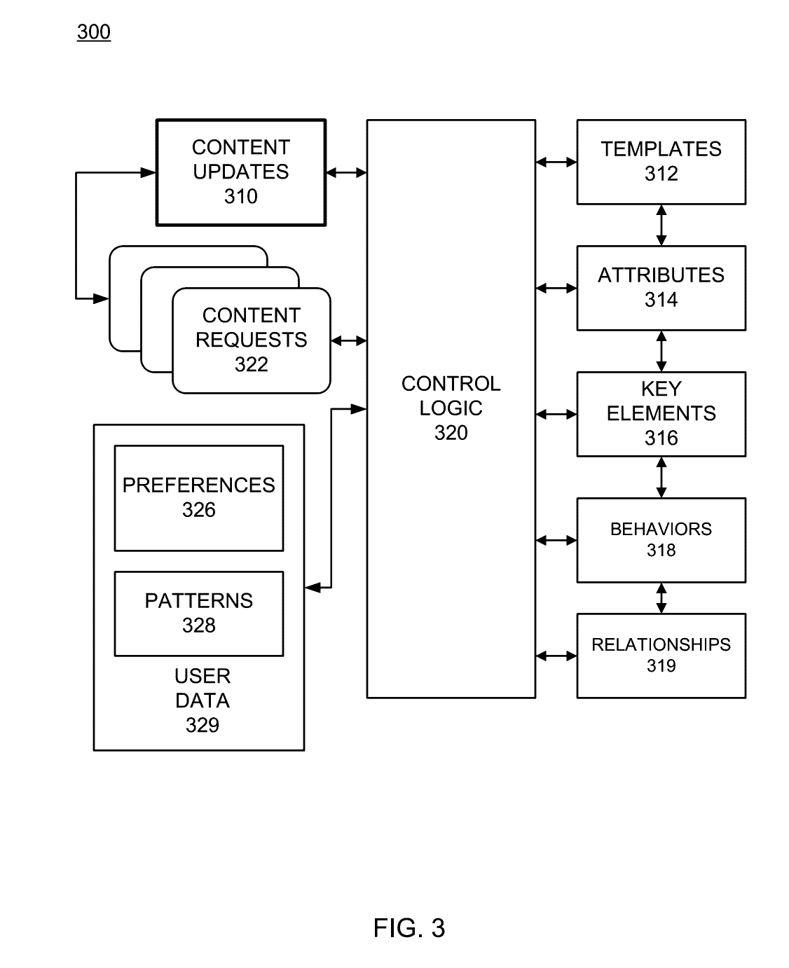

FIG. 3 illustrates a control logic configuration with various input and outputs utilized by the application to create a particular result. For instance, the control logic 320 may receive certain content updates 310 to store in the database and requests 322 from the application to provide a contextual image or video to illustrate the detected context. The user preferences 326 and patterns 328 may be part of the user data 329 that is utilized to arrive at the avatar creation and update. The output may include avatar templates 312, attributes 314 added to those templates, key elements 316 which dictate how the attributes are to be included and displayed with the avatar and behaviours 318, which provide a basis for how the user is feeling as a prediction and also relationships 319 among the attributes.

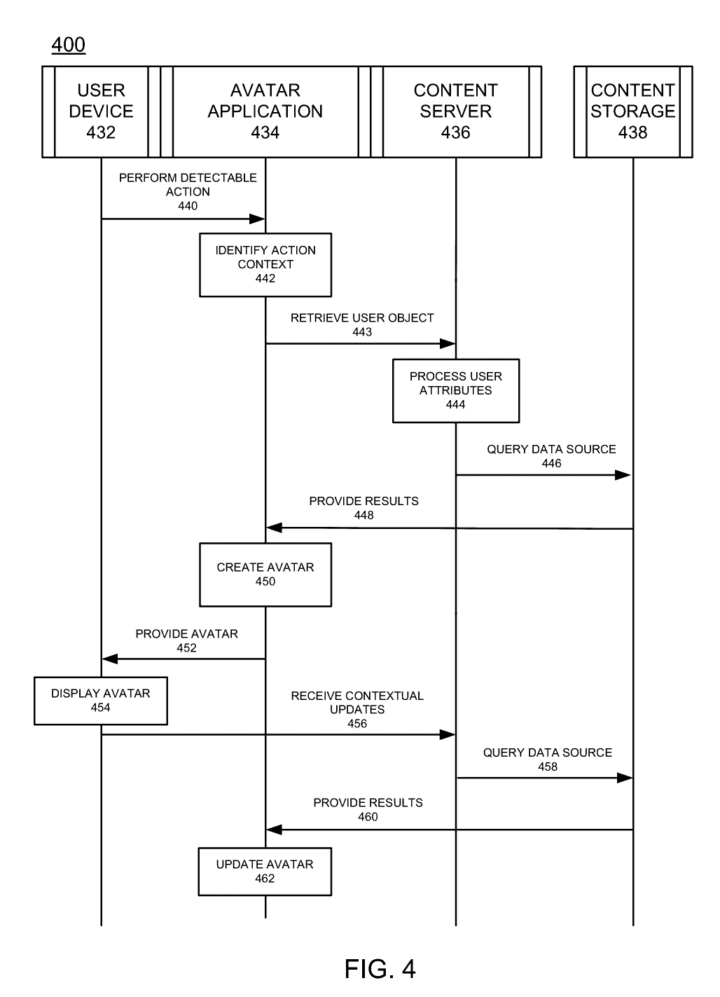

FIG. 4 illustrates an example system communication diagram according to an example method of operation. Referring to FIG. 4, the example communications may include a user device 432 such as a laptop or smartphone initiate an application which can trigger a detectable action 440 to be identified by the avatar application 434 monitoring the user actions. The action can be flagged and its context may be parsed or extracted 442 while a user object is retrieved to represent the user 443. The server 436 may process the user attributes 444 and link the attributes to the object for modifications. A content storage 438 data source may be queried 446 to provide the avatar base image needed for modification and customization. The results 448 are then provided to the application which creates the avatar 450 and provides the avatar 452 to the user device for display 454. The contextual updates may be received 456 for further modification depending on the types of new changes observed from the user input. As a result, the data source may be queried again 458 to retrieve the avatar images 460 and content for additional updating 462.

In another example, a “User” may be observing a user profile on a social networking site, such as FACEBOOK. In the setup procedure, a remote user may create an avatar via a “create avatar” application that takes a person's photo and/or videos and creates a standard “avatar” file. This file contains a model of the remote user, such as a digital, comprehensive version of verbal descriptions of visual, physical and behavioral characteristics, such as the type of information a police report may use, including tall, female with long wavy strawberry-blond hair, blue eyes, long nose and thin pale lips, often smiles, frequently touches hair. The avatar file is then built with a large amount of predefined settings determined by the template used for a “female person”, one example of standard behaviors could be he or she blinks on average every 10 seconds, with standard deviation of 5 seconds. These settings are modified by behaviors observed in the photo/video materials (e.g. “blinks on average every 7 seconds, with standard deviation of 11 seconds”). Behaviors not observed in the submitted photo/video materials remain default (e.g. change to the lips line when frowning). Upon finalizing his or her avatar creation, the remote user may have an opportunity to add/override default or observed settings with user-friendly options like “smile more often” or “don't blink”. The avatar file doesn't retain specific photo/video sequences from the original materials, but contains enough information to synthesize similar images and video sequences. The avatar file is added by the remote user to the user's Facebook profile, when user are opening remote user's Facebook profile, the avatar file is accessed by a “display avatar” application that reads the description of a remote user's visual, physical and behavioral characteristics, and synthesizes a life-like endless video sequence showing the remote user in the context of the Facebook profile viewing. For example, if it is morning time and the original photo/video materials contained a morning scene on a tennis court, the avatar may be shown in tennis attire, bouncing a tennis ball on a court.

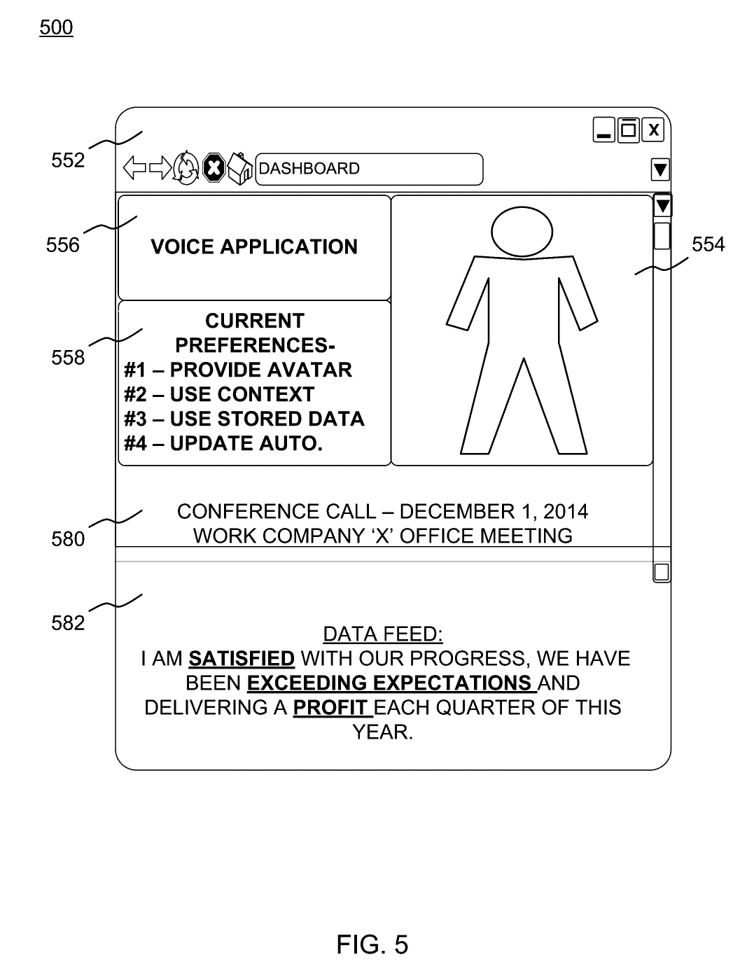

FIG. 5 illustrates an example user interface 500 of a user application according to example embodiments. In this example, a web-based application 552 may have a first information portion 556 a preference window 558 and a user avatar input section 554. The conference application may also have a current status window 580 and a data feed 582. The content provided as input by the user may include a series of comments 582 which are parsed to identify words that can be used to link content to the avatar 554. In this example, the words “satisfied”, “exceeding expectations” and “profit” may be identified as leading to a happy modification to the avatar model.

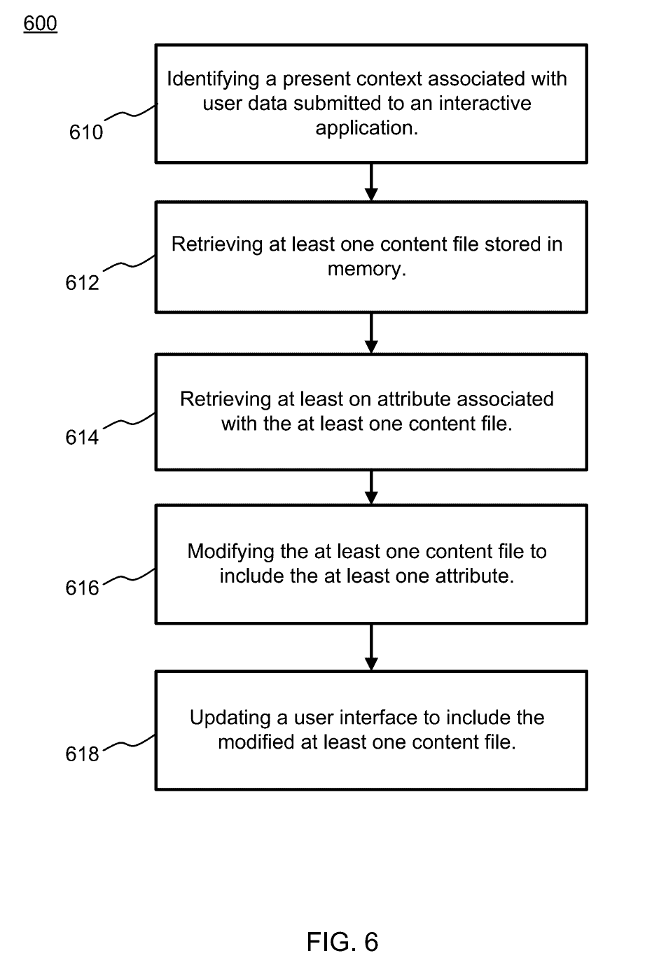

FIG. 6 illustrates an example flow diagram according to example embodiments. Referring to FIG. 6, the flow diagram 600 includes identifying a present context associated with user data submitted to an interactive application at operation 610, retrieving at least one content file stored in memory at operation 612 and retrieving at least on attribute associated with the at least one content file at operation 614. The process also includes modifying the at least one content file to include the at least one attribute at operation 616 and updating a user interface to include the modified at least one content file at operation 618.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

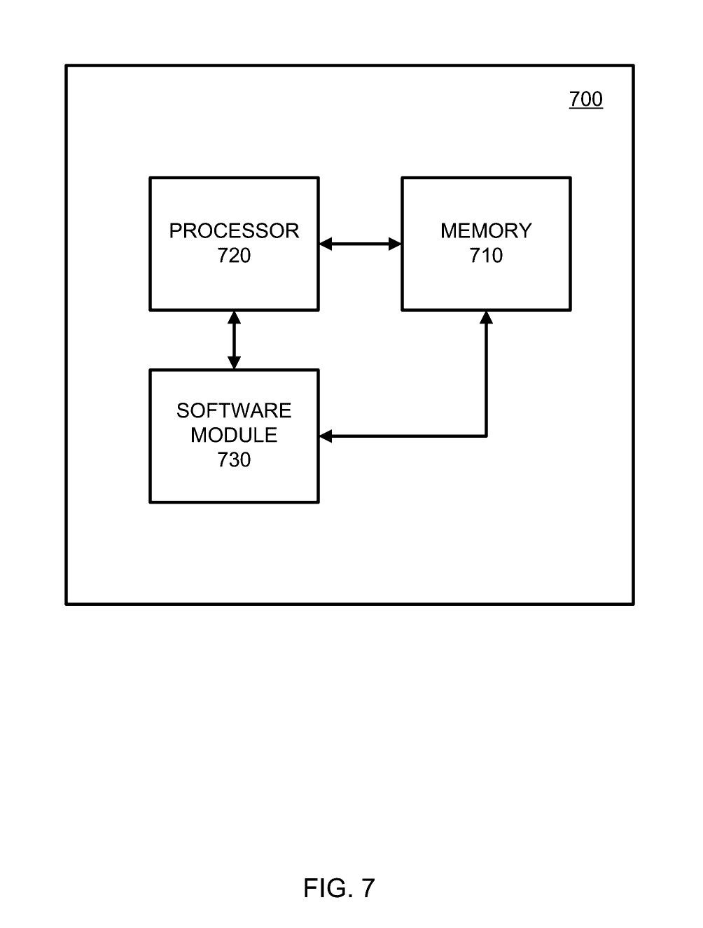

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 7 illustrates an example network element 700, which may represent any of the above-described network components.

As illustrated in FIG. 7, a memory 710 and a processor 720 may be discrete components of the network entity 700 that are used to execute an application or set of operations. The application may be coded in software in a computer language understood by the processor 720, and stored in a computer readable medium, such as, the memory 710. The computer readable medium may be a non-transitory computer readable medium that includes tangible hardware components in addition to software stored in memory. Furthermore, a software module 730 may be another discrete entity that is part of the network entity 700, and which contains software instructions that may be executed by the processor 720. In addition to the above noted components of the network entity 700, the network entity 700 may also have a transmitter and receiver pair configured to receive and transmit communication signals (not shown).

Although an exemplary embodiment of the system, method, and computer readable medium of the present invention has been illustrated in the accompanied drawings and described in the foregoing detailed description, it will be understood that the invention is not limited to the embodiments disclosed, but is capable of numerous rearrangements, modifications, and substitutions without departing from the spirit or scope of the invention as set forth and defined by the following claims. For example, the capabilities of the systems described can be performed by one or more of the modules or components described herein or in a distributed architecture. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

1. A method comprising:
identifying a present context associated with user data submitted to an interactive application;
retrieving at least one content file stored in memory;
retrieving a plurality of attributes associated with the at least one content file;
modifying the at least one content file to include the plurality of attributes; and
updating a user interface to include the modified at least one content file.

2. The method of claim 1, wherein the present context is identified based on a parsing of terms included in the user data and processing the terms to identify a user emotion and a numerical degree of emotion.

3. The method of claim 1, wherein the at least one content file comprises an image of a face.

4. The method of claim 1, wherein the at least one attribute comprises at least one facial feature of the face.

5. The method of claim 3, further comprising:
creating a timeline of modifications to the content file comprising a plurality of transitions and modifications to the content file over a predefined interval of time; and
executing the timeline of modifications to the content file and modifying the content file as the transitions and the modifications appear in the timeline.

6. The method of claim 5, further comprising:
displaying a modified content file comprising the modifications and the transitions to the content file over the predefined interval of time.

7. The method of claim 1, further comprising:
modifying a plurality of facial expressions based on the plurality of attributes, wherein the modified content file comprises a plurality of facial expressions and facial feature movements over the predefined interval of time.

8. An apparatus comprising:
a display configured to display a user interface; and
a processor configured to
identify a present context associated with user data submitted to an interactive application;
retrieve at least one content file stored in memory;
retrieve a plurality of attributes associated with the at least one content file;
modify the at least one content file to include the plurality of attributes; and
update a user interface to include the modified at least one content file.

9. The apparatus of claim 8, wherein the present context is identified based on the processor parsing terms included in the user data and processing the terms to identify a user emotion and a numerical degree of emotion.

10. The apparatus of claim 8, wherein the at least one content file comprises an image of a face.

11. The apparatus of claim 8, wherein the at least one attribute comprises at least one facial feature of the face.

12. The apparatus of claim 10, wherein the processor is further configured to
create a timeline of modifications to the content file comprising a plurality of transitions and modifications to the content file over a predefined interval of time; and
execute the timeline of modifications to the content file and modify the content file as the transitions and the modifications appear in the timeline.

13. The apparatus of claim 12, wherein the processor is further configured to display a modified content file comprising the modifications and the transitions to the content file over the predefined interval of time.

14. The apparatus of claim 8, wherein the processor is further configured to
modify a plurality of facial expressions based on the plurality of attributes, wherein the modified content file comprises a plurality of facial expressions and facial feature movements over the predefined interval of time.

15. A non-transitory computer readable medium configured to store instructions that when executed causes a processor to perform:
identifying a present context associated with user data submitted to an interactive application;
retrieving at least one content file stored in memory;
retrieving a plurality of attributes associated with the at least one content file;
modifying the at least one content file to include the plurality of attributes; and
updating a user interface to include the modified at least one content file.

16. The non-transitory computer readable medium of claim 15, wherein the present context is identified based on a parsing of terms included in the user data and processing the terms to identify a user emotion and a numerical degree of emotion.

17. The non-transitory computer readable medium of claim 15, wherein the at least one content file comprises an image of a face.

18. The non-transitory computer readable medium of claim 15, wherein the at least one attribute comprises at least one facial feature of the face.

19. The non-transitory computer readable medium of claim 18, wherein the processor is further configured to perform:
creating a timeline of modifications to the content file comprising a plurality of transitions and modifications to the content file over a predefined interval of time; and
executing the timeline of modifications to the content file and modifying the content file as the transitions and the modifications appear in the timeline.

20. The non-transitory computer readable medium of claim 19, wherein the processor is further configured to perform:
displaying a modified content file comprising the modifications and the transitions to the content file over the predefined interval of time; and
modifying a plurality of facial expressions based on the plurality of attributes, wherein the modified content file comprises a plurality of facial expressions and facial feature movements over the predefined interval of time.
